(19) United States
(12) Patent Application Publication
(10) Pub. No.: US 2006/0011441 A1
(43) Pub. Date: Jan. 19, 2006

(54) Ball ramp actuator having differential drive

(76) Inventor: Dan J. Showalter, Plymouth, MI (US)

Correspondence Address: BorgWarner, Inc.;Patent Administrator, 3850 Hamlin Road, Auburn Hills, MI, 48326-2872, US

(21) Appl. No.: 10/892,706

(22) Filed: Jul. 16, 2004

(51) Int. Cl. B60K 23/00; F16D 28/00

(52) U.S. Cl. 192/84.6; 192/20; 192/84.7; 192/93 A

(57) ABSTRACT

A ball ramp actuator for friction clutch packs and the like includes a first circular member having a first plurality of gear teeth and a second circular member disposed adjacent the first circular member and having a second plurality of gear teeth distinct in number from the first plurality of gear teeth. On adjacent opposed faces of the circular members are oblique cams or ramped devices such as opposed recesses and load transferring members which drive the circular members apart upon relative rotation therebetween. Such relative rotation is achieved by a motor driving the rotatable members through a pinion. A friction clutch assembly, disposed adjacent the rotatable members transfers drive energy from an input to an output when the rotatable member differentially rotate and separate, causing compression of the friction clutch assembly.

### BACKGROUND OF THE INVENTION

The invention relates generally to a ball ramp actuator for clutches and the like and more specifically to a ball ramp actuator having differentially driven members with cam or ramp features which separate axially upon differential rotation.

Notwithstanding significant sales of light and medium duty trucks, an emphasis upon improved vehicle performance and gas mileage remains. Within the arena of engineering details, this emphasis takes several forms. The first is the obvious approach of weight reduction. Such weight reduction exempts virtually no part of the vehicle: engine, power train, chassis, suspension, steering gear body, seating, windows, and options.

The high gas mileage goal also affects the design of electrical components as reducing current consumption has a corresponding affect on gas consumption. This emphasis has encouraged the use of electrical devices which exhibit reduced current consumption. Components which exhibit both significant power consumption and have significant duty cycles, such as electric clutches, are carefully studied.

One class of clutches is referred to as ball ramp clutches. These clutches, in addition to a friction plate or multiple plate friction clutch pack, include an operator comprising a pair of adjacent plates having a plurality of opposed arcuate ramped recesses which each receive a ball bearing or, alternatively, a plurality of opposed, oblique cam surfaces. Relative rotation of the plates causes the ball bearings to ride up the ramps of the recesses or the cams to ride up one another and separate the plates, thereby engaging the clutch. An electromagnetic coil may be utilized to create drag which causes the plates to rotate relatively. In this design, it is the speed differential and the energy of such speed differential which causes engagement of the clutch. That is, the electromagnetic force generated by the electromagnetic coil does not directly engage the clutch but acts upon the ball ramp operator which, in turn, engages the clutch. So configured, the electromagnetic coil can be significantly smaller and consume less electricity than a direct acting clutch. In addition to the weight reduction, heat dissipation is also a less significant concern. Thus, overall, a ball ramp clutch actuator can be smaller and more electrically efficient than a direct acting electromagnetic clutch.

Actuation of the clutch, however, as noted, does require relative rotation, that is, a speed difference between the input and the output of the clutch. This is seldom an operational disadvantage, however, inasmuch as if there is no speed difference, there is no need to engage the clutch and, in fact, engagement requires only the smallest speed differential.

Nonetheless, the ability to effect clutch engagement independent of a shaft speed difference is seen as a benefit in certain operational conditions. The present invention addresses this desire.

### SUMMARY OF THE INVENTION

A ball ramp actuator for friction clutch packs and the like includes a first circular member having a first plurality of gear teeth and a second circular member disposed adjacent the first circular member and having a second plurality of gear teeth distinct in number from the first plurality of gear teeth. On adjacent, opposed faces of the circular members are oblique cams or ramp features such as opposed recesses and load transferring members which drive the circular members apart upon relative rotation therebetween. Such relative rotation is achieved by a motor driving the rotatable members through a pinion. A friction clutch pack, disposed adjacent the rotatable members transfers drive energy from an input to an output when the rotatable members differentially rotate and separate, causing compression of the friction clutch assembly. Various other drive configurations such as a pinion with axially adjacent regions having disparate numbers of teeth which provide differential rotation of the clutch members are encompassed by the present invention.

It is thus an object of the present invention to provide a ball ramp actuator for a friction clutch assembly which is driven by a motor.

It is a further object of the present invention to provide a ball ramp actuator for a friction clutch assembly capable of actuating the clutch assembly without a speed difference between the input and output of the clutch assembly.

It is a still further object of the present invention to provide a ball ramp actuator for a friction clutch pack having two differentially driven camming members.

It is a still further object of the present invention to provide a ball ramp actuator having circular cam plates which are differentially driven by a bi-directional motor.

It is a still further object of the present invention to provide a cam actuator for a friction clutch assembly having two adjacent differentially rotating members which separate upon relative rotation therebetween.

Further objects and advantages of the present invention will become apparent by reference to the following description of the preferred embodiment and appended drawings wherein like reference numbers refer to the same component, element, or feature.

### BRIEF DESCRIPTION OF THE DRAWINGS

FIG. 1 is a diagrammatic view of a drive train of an adaptive four-wheel drive motor vehicle having a transfer case assembly incorporating the present invention;

FIG. 2 is a side, elevational view in partial section of a transfer case assembly having a ball ramp actuator and friction clutch assembly according to the present invention;

FIG. 3 is an end elevational view in partial section of the ball ramp members of a ball ramp actuator according to the present invention;

FIG. 4 is an alternate embodiment cam operator of a ball ramp actuator according to the present invention;

FIG. 5 is a diagrammatic view of a motor vehicle drive train including a transaxle and a ball ramp actuator and friction clutch assembly disposed at a rear differential of the drive train;

FIG. 6 is an enlarged, full sectional view of a ball ramp actuator and friction clutch assembly according to the present invention disposed at a rear differential;

FIG. 7 is a full, sectional view of a twin clutch rear differential incorporating the present invention;

FIG. 8 is a fragmentary, full sectional view of a first alternate embodiment of a ball ramp actuator for a friction clutch assembly; and

FIG. 9 is a fragmentary, full sectional view of a second alternate embodiment of a ball ramp actuator for a friction clutch assembly.

### DETAILED DESCRIPTION OF THE PREFERRED AND ALTERNATE EMBODIMENTS

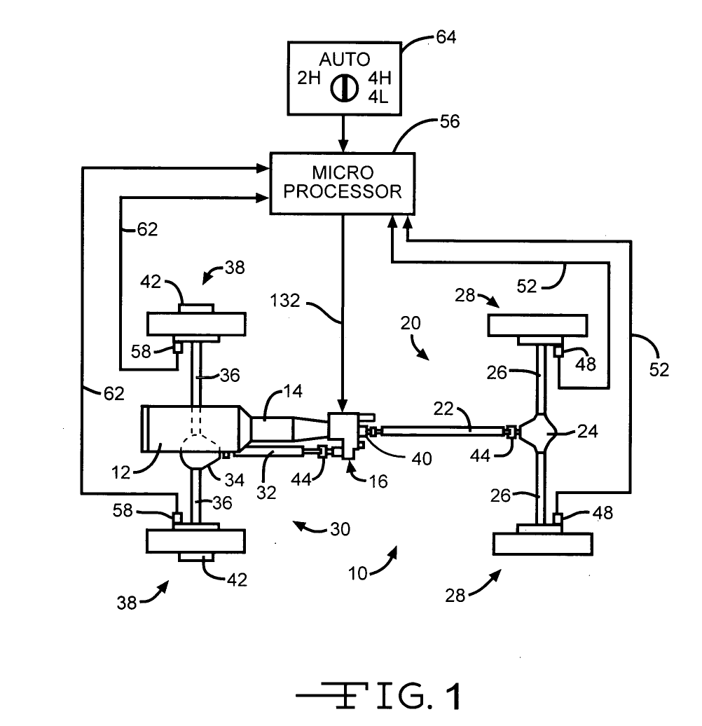

Referring now to FIG. 1, a four-wheel vehicle drive train utilizing the present invention is diagramatically illustrated and designated by the reference number 10. The four-wheel vehicle drive train 10 includes a prime mover 12 which is coupled to and directly drives a transmission 14. The prime mover 12 may be a gas, Diesel or hybrid power plant. The output of the transmission 14 directly drives a transfer case assembly 16 which provides motive power to a primary or rear drive driveline 20 comprising a primary or rear prop shaft 22, a primary or rear differential 24, a pair of live primary or rear axles 26 and a respective pair of primary or rear tire and wheel assemblies 28.

The transfer case assembly 16 also selectively provides motive power to a secondary or front driveline 30 comprising a secondary or front prop shaft 32, a secondary or front differential 34, a pair of live secondary or front axles 36 and a respective pair of secondary or front tire and wheel assemblies 38. The front tire and wheel assemblies 38 may be directly coupled to a respective one of the front axles 36 or, if desired, a pair of manually or remotely activatable locking hubs 42 may be operably disposed between the front axles 36 and a respective one of the tire and wheel assemblies 38 to selectively connect same. Finally, both the primary driveline 20 and the secondary driveline 30 may include suitable and appropriately disposed universal joints 44 which function in conventional fashion to allow static and dynamic offsets and misalignments between the various shafts and components.

Disposed in sensing relationship with each of the rear tire and wheel assemblies 28 is a wheel speed sensor 48. Preferably, the rear wheel speed sensors 48 may be the same sensors utilized with, for example, an antilock brake system (ABS) or other vehicle control or traction enhancing system although they may, of course, be independent of any other system. Alternatively, a single sensor (not illustrated), disposed to sense rotation of the primary or rear prop shaft 22 may be utilized. Signals from the sensors 48 are provided in electrical lines 52 to a microprocessor 56. Similarly, disposed in sensing relationship with the front tire and wheel assemblies 38 are respective front wheel speed sensors 58 which provide signals to the microprocessor 56 in electrical lines 62. Once again, the sensors 58 may be a part of or shared with an antilock brake system or other traction control system or they may be independent thereof.

Typically, an operator selectable switch 64 may be utilized and is generally disposed within reach of the vehicle operator in the passenger compartment (not illustrated). The switch 64 may be adjusted to select various operating modes such as two-wheel high gear, automatic, i.e., on-demand or adaptive operation, four-wheel high gear or four-wheel low gear depending upon the particular vehicle, configuration of the transfer case assembly 16 and the driver's desires. One such system which provides torque delivery to the secondary driveline 30 in increments or decrements in response to a sensed wheel speed difference between the primary driveline 20 and the secondary driveline 30 is disclosed in co-owned U.S. Pat. No. 5,407,024.

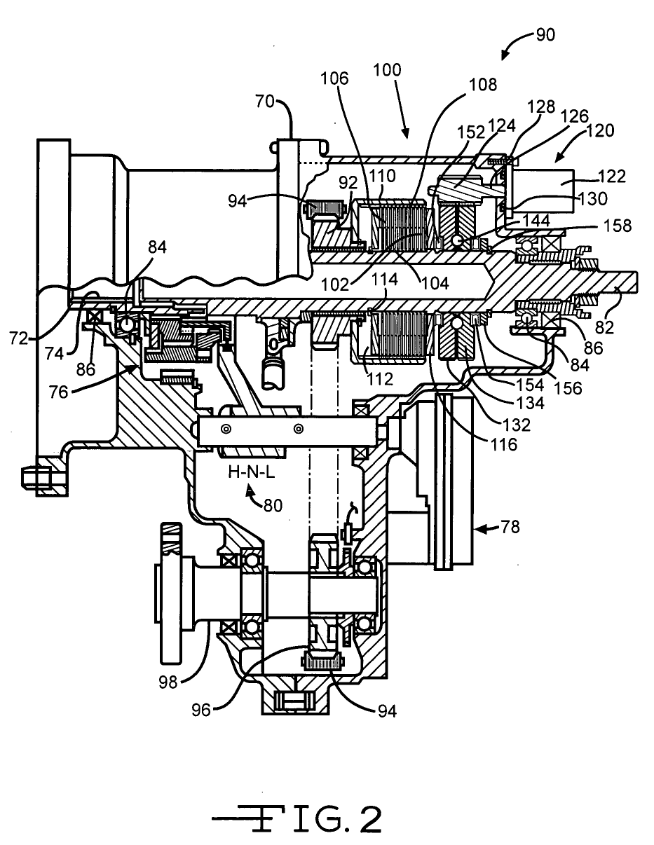

Referring now to FIG. 2, a typical two-speed transfer case assembly 16 includes a cast, multiple piece housing 70 having a plurality of planar sealing surfaces, openings for shafts and bearings and various recesses, shoulders, counterbores and the like which receive, support or mount various assemblies or components of the transfer case assembly 16. An input shaft 72 includes female or internal splines 74 or other suitable coupling structures which drivingly engage and couple the output of the transmission 14, illustrated in FIG. 1, to the input shaft 72. In the two-speed transfer case assembly 16, the input shaft 72 provides motive power to a planetary gear speed reduction assembly 76 which is controlled by a two or three position operator assembly 78 which may be electrically pneumatically or hydraulically powered and shift fork and cam assembly 80 to achieve and provide a first, direct drive speed range (high gear), neutral and a second, reduced speed drive range (low gear). The output of the planetary gear speed reduction assembly 76 is provided to a primary output shaft 82 which is coupled to, and drives the primary driveline 20. In a single speed transfer case assembly, the planetary gear assembly 76 and the operator assembly 78 are not present and the input shaft 72 or its equivalent directly drives the primary output shaft 82. Suitable ball bearing assemblies 84 rotatably support the shafts 72 and 82 and oil seals 86 provide a fluid tight seal between the shafts 72 and 82 and the housing 70.

A modulating clutch assembly 90 is operably disposed between the primary output shaft 82 and a chain drive sprocket 92 freely rotatably disposed about the primary output shaft 82. The chain drive sprocket 92 is engaged by a drive chain 94 which also engages a driven chain sprocket 96 which is secured to a secondary output shaft 98. The secondary output shaft 98 is coupled to and drives the secondary driveline 30.

The modulating clutch assembly 90 includes a friction clutch pack assembly 100 having a first plurality of smaller diameter clutch plates 102 which are splined to the primary output shaft 82 by a plurality of interengaging splines 104. The first plurality of smaller diameter clutch plates 102 are interleaved with a second plurality of larger diameter clutch plates 106 which are coupled by interengaging splines 108 to a bell-shaped clutch housing 110. The first and second pluralities of interleaved clutch plates 102 and 106 include suitable friction material (not illustrated) secured to at least one face of each of the clutch plates 102 and 106.

The bell-shaped clutch housing 110 is rotationally coupled to the chain drive sprocket 92 by interengaging splines, axially extending lugs and apertures, welds, or other permanent or disconnectible rotational coupling means. Between the friction clutch pack 100 and the clutch housing 110 is a circular backup plate 112 which is restrained against axial motion to the left, as illustrated in FIG. 2, by a cooperating snap ring and channel 114 in the primary output shaft 82. On the opposite side or face of the friction clutch pack assembly 100 is a circular apply plate 116.

The modulating clutch assembly 90 also includes a differential gear operator assembly 120. The differential operator assembly 120 includes a fractional horsepower bi-directional electric motor 122 which directly drives a pinion gear 124 through an output shaft 126. The electric motor 122 is preferably secured to the housing 70 of the transfer case assembly 16 by a plurality of fasteners 128, one of which is illustrated in FIG. 2. A suitable seal such as an O-ring 130 is disposed between the outer surface of the transfer case assembly 16 and a mounting plate of the electric motor 122 and provides a suitable fluid tight seal.

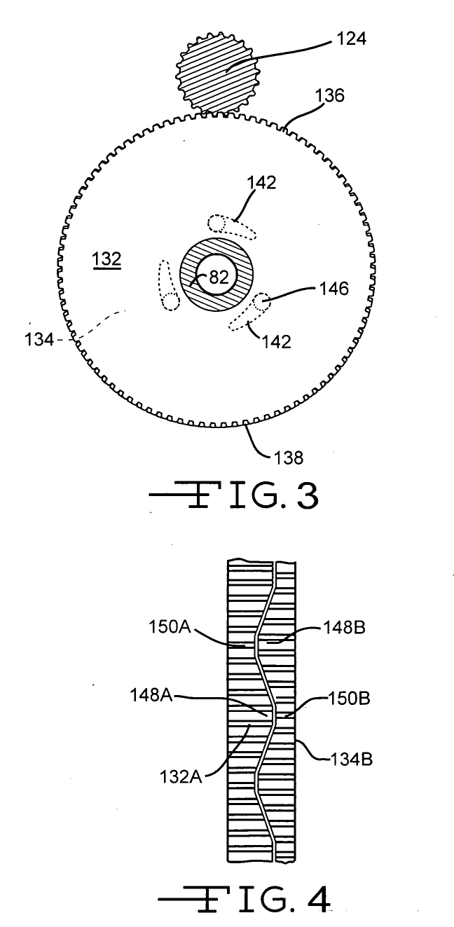

Referring now to FIGS. 2 and 3, the pinion gear 124 simultaneously engages a first circular cam member 132 and a second, adjacent circular cam member 134. The circular cam members 132 and 134 have gear teeth 136 and 138 disposed about their peripheries. The number of gear teeth 136 and 138 on each of the circular cam members 132 and 134 is not the same. For example, the first cam member 132 may define or have 180 gear teeth 138 about its periphery whereas the second cam member 134 defines or has 181 teeth about its periphery. The profiles of the gear teeth 136 and 138, their pressure angles and overall geometry are chosen to be a compromise with the gear teeth of the pinion 124 such that any errors are split between the gear teeth 136 and 138 of the cam members 132 and 134 and thus are equally but only slightly variant from the nominal or appropriate values. A one tooth difference between the circular cam members 132 and 134 minimizes these errors but a larger difference between the number of teeth, increasing the rotational differential between the circular cam member 132 and 134 is possible, especially if the diameter of the cam members 132 and 134 is increased on the size of the gear teeth 136 and 138 is decreased.

On the opposed, adjacent faces of the cam members 132 and 134 are camming features. On the cam member 132 are curved, teardrop shaped ramped recesses 142. Complementarily configured curved, teardrop shaped ramped recesses 144 are formed in the second cam member 134. Received within the curved, ramped recesses 142 and 144 are load transferring members such as ball bearings 146. It will be appreciated that as the circular cam members 132 and 134 rotate relative to one another, the ball bearings 146 and the ramped recesses 142 and 144 axially separate the cam members 132 and 134. The ramps and ball bearings may be readily replaced with other, analogous mechanical assemblies such as ramps and roller bearings or oblique, opposed camming surfaces to name but two.

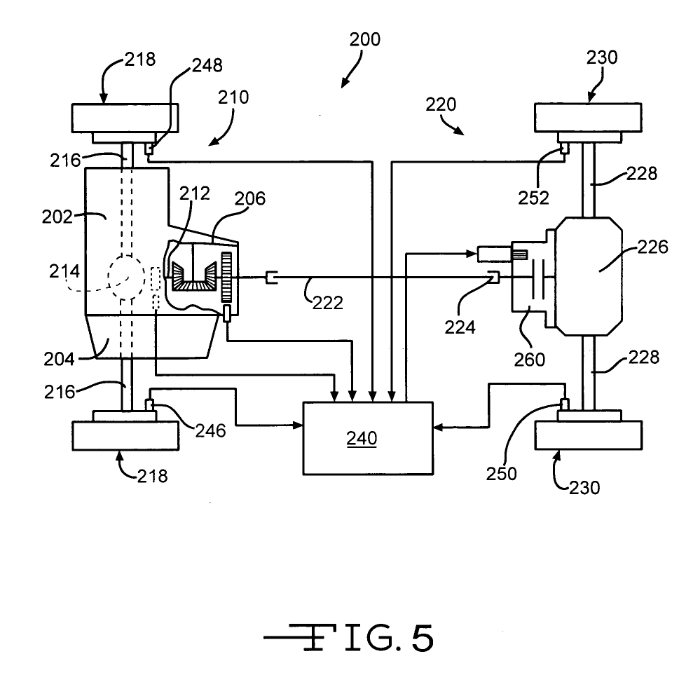

Referring briefly to FIG. 4, an alternate embodiment utilizing cam surfaces, noted above, is illustrated. In a first circular member 132A, a plurality of projections 148A and recesses 150A form oblique ramps. On a second circular member 134B, a complementary plurality of projections 148B and recesses 150B form complementary, oblique ramps. As the circular members 132A and 134B rotate relative (differentially) to one another, they are driven axially apart.

It should be appreciated that both the factor of differential rotation, i.e., how quickly differential rotation of the circular cam members 132 and 134 occurs and how quickly such rotation causes axial, clutch engaging, translation may be characterized as the amplification of the operator assembly 120 and may be adjusted to satisfy various design criteria. Slower differential rotation and shallower cam angles requires significant rotation such that even a small electric motor 122 has the capability to apply significant compressive force to the associated friction clutch pack assembly 100, which may be characterized as high (force) amplification. On the other hand, a greater numerical gear tooth difference and steep cams (low amplification) will achieve quicker clutch engagement and generally require a more powerful electric motor 122.

Between the first cam member 132 and the apply plate 116 is a first ball or roller thrust bearing 152 which transmits axial force but allows the adjacent apply plate 116 and first cam member 132 to rotate fully independently of one another. Adjacent the second cam member 134 is a second ball or roller thrust bearing 154. Adjacent the second ball or roller thrust bearing 154 is a backup washer 156 which has axial travel limited by a complementary snap ring and groove 158 formed in the primary output shaft 82. The second thrust bearing 154 allows the second cam member 134 to rotate fully independently of the primary output shaft 82 and the backup washer 156. The circular backup plate 112 and the backup washer 156 as well as the adjacent snap rings and grooves 114 and 158 function as stops and the termini of a reaction force circuit against which the differential gear clutch operator 120 functions and contains all forces and reaction forces within the length of the primary output shaft 82 between the snap rings and grooves 114 and 158.

Referring now to FIG. 5, an adaptive four-wheel vehicle drive train is diagrammatically illustrated and designated by the reference number 200. The four-wheel vehicle drive train 200 includes a prime mover 202 such as a gasoline, Diesel or natural gas fueled internal combustion engine or hybrid power plant which is coupled to and directly drives a transaxle 204. The output of the transaxle 204 drives a primary or front driveline 210 and a second or rear driveline 220. The primary driveline 210 comprises a front or primary propshaft 212, a front or primary differential 214, a pair of live front axles 216 and a respective pair of front tire and wheel assemblies 218. It should be appreciated that the front or primary differential 214 is conventional.

The transaxle 204, through a power takeoff 206, also provides drive torque to the secondary or rear drive line 220 comprising a secondary propshaft 222 having appropriate universal joints 224, a rear or secondary axle assembly 226, a pair of live secondary or rear axles 228 and a respective pair of secondary or rear tire and wheel assemblies 230.

As utilized herein with regard to the secondary axle assembly 226, the term “axle” is used to identify a device for receiving drive line torque, distributing it to two generally aligned, transversely disposed drive axles and accommodating rotational speed differences resulting from, inter alia, vehicle cornering.

Furthermore, the foregoing and following description relates to a vehicle wherein the primary drive line 210 is disposed at the front of the vehicle and, correspondingly, the secondary drive line 220 is disposed at the rear of the vehicle, such a vehicle commonly being referred to as a (primary) front wheel drive vehicle or adaptive four-wheel drive vehicle. Nonetheless, it should be appreciated that this invention is equally suited for use in a (primary) rear wheel drive vehicle having the drive component location reversed.

Associated with the vehicle drive train 200 is a controller or microprocessor 240 which receives signals from a plurality of sensors and provides a control, i.e., actuation, signals to the rear or secondary axle assembly 226.

The vehicle drive train 200 also includes a first variable reluctance or Hall Effect sensor 246 which senses the rotational speed of the left primary (front) tire and wheel assembly 218 and provides a signal to the microprocessor 240. A second variable reluctance or Hall Effect sensor 248 senses the rotational speed of the right primary (front) tire and wheel assembly 218 and provides a signal to the microprocessor 240. A third variable reluctance or Hall effect sensor 250 associated with the left secondary (rear) tire and wheel assembly 230 senses its speed and provides a signal to the microprocessor 240. Finally, a fourth variable reluctance or Hall effect sensor 252 associated with the right secondary (rear) tire and wheel assembly 230 senses its speed and provides a signal to the microprocessor 240. It should be understood that the speed sensors 246, 248, 250 and 252 may be those sensors mounted in the vehicle to provide signals for anti-lock brake systems (ABS) or other speed sensing and traction control systems or may be independent, i.e., dedicated, sensors. It is also to be understood that an appropriate and conventional counting or tone wheel (not illustrated) is associated with each of the respective tire and wheel assemblies 218 and 230 in proximate sensing relationship with each of the speed sensors 246, 248, 250 and 252.

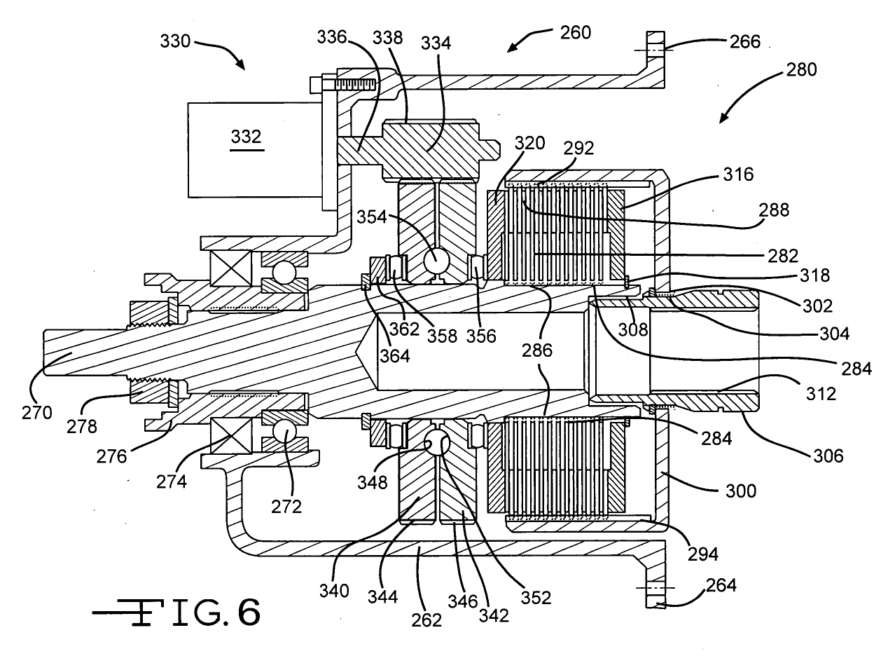

Referring now to FIGS. 5 and 6, a modulating rear axle clutch assembly 260 is operably disposed between the output of the power takeoff 206 and the secondary axle assembly 226. The rear axle clutch assembly 260, incorporating the present invention, includes a generally bell shaped housing 262 having an annular flange 264 defining a plurality of through openings 266 which receive complementarily sized threaded fasteners (not illustrated) utilized to secure the clutch assembly 260 and specifically the housing 262 to the housing of the secondary axle assembly 226 illustrated in FIG. 5. The clutch assembly 260 includes an input shaft 270 which is supported within the housing upon an antifriction bearing such as a ball bearing assembly 272. A suitable oil seal 274 provides a seal between the housing 262 and the rotating input shaft 270 to prevent the ingress of contaminants and egress of clutch lubricating fluid. The input shaft 270 may include a collar or hub 276 or other component which may be a portion of a universal joint or other driveline feature. A threaded lock nut 278 may be utilized to secure the collar 276 to the input shaft 270.

Concentrically disposed about the input shaft 270 is a friction clutch pack assembly 280. The friction clutch pack assembly 280 includes a first plurality of smaller diameter clutch plates 282 having internal or female splines 284 which are complementary to and engage external or male splines 286 formed on a portion of the input shaft 270. Interleaved with the first plurality of smaller diameter clutch plates 282 is a second plurality of larger diameter clutch plates 288. The second plurality of larger diameter clutch plates 288 includes external or male splines or gear teeth 292 which are complementary to and engage internal or female splines 294 formed on the inner surface of a bell shaped output housing 300. The bell shaped output housing 300 defines a concentric aperture having a plurality of female or internal splines or gear teeth 302 which are complementary to and engage male splines or gear teeth 304 on a stub output shaft 306. The stub output shaft 306 is received within a counterbore 308 in the input shaft 270. The inner surface of the stub output shaft 306 preferably includes internal or female splines or gear teeth 312 which may be engaged by a driven member (not illustrated) disposed within the rear axle assembly 226.

Between the friction clutch pack assembly 280 and the bell housing 300 is a backup or stop plate 316 which is maintained in position on the input shaft 270 by a cooperating snap ring and groove 318 formed in the input shaft 270. On the opposite face of the friction clutch pack assembly 280 is an apply plate 320.

The friction clutch pack assembly 280 is actuated by a cam actuator assembly 330 which includes a fractional horsepower, bi-directional electric motor 332. The electric motor 332 drives a pinion gear 334 through an output shaft 336. The pinion gear 334 includes uniform axially extending gear teeth 338 about its periphery. The gear teeth 338 of the pinion 334 simultaneously engage a first circular cam plate 340 and a second circular cam plate 342. The first circular cam plate 340 includes gear teeth 344 disposed about its periphery. The second circular cam plate 342 also includes gear teeth 346 disposed about its periphery. The numbers of gear teeth 344 and 346 are not equal. Preferably, for example, there are 180 gear teeth 344 on the first circular cam plate 340 and 181 gear teeth 346 on the second circular cam plate 342. Thus, as the circular cam plates 340 and 342 are driven by the pinion 344, they differentially rotate, i.e., the second cam plate 342 rotates slightly slower than the first cam plate 340. The numbers of gear teeth 344 and 346 recited are given by way of example only and it should be understood that the numbers can vary widely depending upon the size of the gears 340 and 342, the size of the pinion 334 and the operating speed desired.

The first circular cam plate 340 includes a plurality of arcuate, teardrop shaped ramped recesses 348 and the second circular cam plate 342 includes a like plurality of arcuate, teardrop shaped ramped recesses 352. Within these ramped recesses are captured load transferring members such as ball bearings 354. As the circular cam plates 340 and 342 differentially rotate, the load transferring members 354 drive them apart.

Between the friction clutch pack assembly 280 and the second circular cam plate 342 is disposed a ball or roller thrust bearing 356 which allows free relative rotation between the apply plate 320 and the second circular cam plate 342. To the left of the first circular cam plate 340 is disposed a second ball or roller thrust bearing assembly 358. Adjacent the thrust bearing assembly 358 is a stop washer 360 which is held in a fixed axial position by a snap ring and groove 364 formed in the input shaft 270. The thrust bearing assembly 358 allows free relative rotation between the first cam member 340 and the stop washer 360. The snap rings and grooves 318 and 364 provide reaction stops and contain the forces and reaction forces of the clutch operator within the input shaft 270.

As illustrated in FIG. 5, the secondary axle modulating clutch 260 functionally precedes the secondary differential or rear axle 226 and controls delivery of torque thereto. Another application for the differential ball ramp clutch actuator encompasses a rear axle assembly without the single modulating clutch 260 and conventional caged differential. These components are replaced by a rear axle assembly 226 having twin independently operable modulating clutches which independently deliver torque to the left and right rear axles 228 and tire and wheel assemblies.

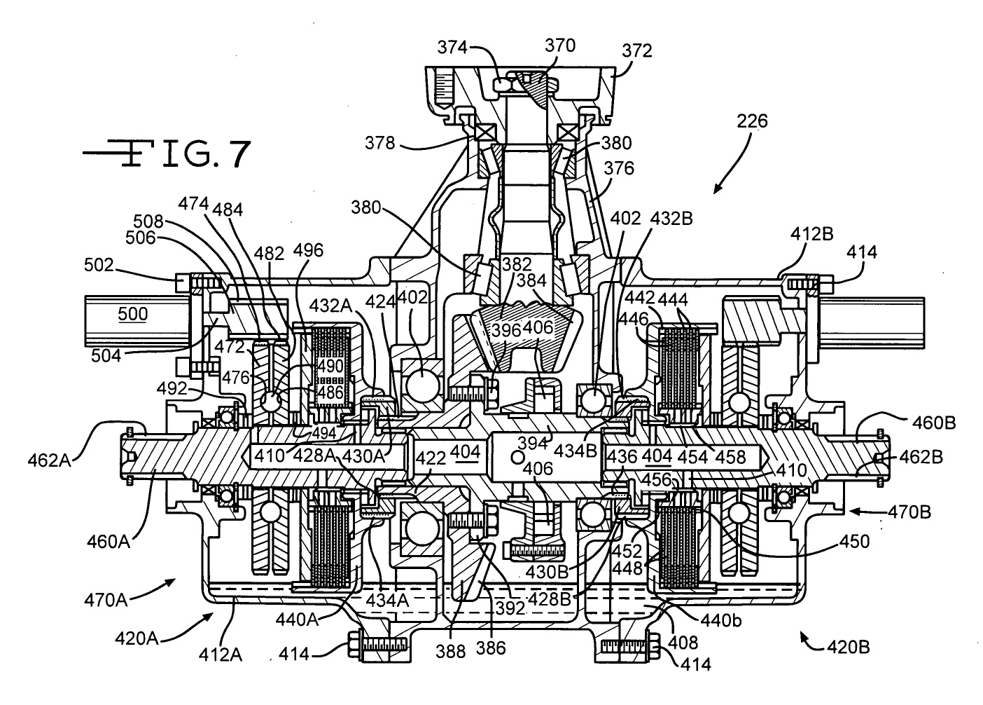

Referring now to FIGS. 5 and 7, the rear or secondary axle assembly 226 includes an input shaft 370 which receives drive torque directly from the secondary propshaft 222. The input shaft 370 may include a flange or cup 372 or similar component which forms a portion of, for example, a universal joint 224 or other connection to the secondary propshaft 222. The flange 372 may be retained on the input shaft 370 by a lock nut 374 or similar device. The input shaft 370 is received within a centrally disposed, axially extending center housing 376 and is surrounded by a suitable oil seal 378 which provides a fluid impervious seal between the housing 376 and the input shaft 370 or an associated portion of the flange 372. The input shaft 370 is preferably rotatably supported by a pair of anti-friction bearings such as the tapered roller bearing assemblies 380. The input shaft 370 terminates in a hypoid or bevel gear 382 having gear teeth 384 which mate with complementarily configured gear teeth 386 on a ring gear 388 secured to a flange 392 on a centrally disposed tubular drive member 394 by suitable threaded fasteners 396.

The tubular drive member 394 is rotatably supported by a pair of anti-friction bearings such as ball bearing assemblies 402. The tubular drive member 394 is hollow and defines an interior volume 404. A pair of scavengers or scoops 406 extend radially through the wall of the tubular drive member 394 and collect a lubricating and cooling fluid 408 driving it into the interior volume 404. The lubricating and cooling fluid 408 is then provided to components in the rear axle assembly 226 through passageways 410 in communication with the interior volume 404 of the tubular drive member 394.

The rear or secondary axle assembly 226 also includes a pair of bell housings 412A and 412B which are attached to the center housing 376 by threaded fasteners 414. The housings 412A and 412B are mirror-images, i. e., left and right, components which each receive a respective one of a pair of modulating clutch assemblies 420A and 420B. But for the opposed, mirror-image arrangement of the two modulating clutch assemblies 420A and 420B, the components of the two clutch assemblies 420A and 420B described below are identical. Accordingly, and for purposes of clarity in FIG. 7, numerical component callouts may appear in either or both of the left and right clutch assemblies 420A and 420B, it being understood that such components reside in and such callouts refer to both assemblies.

Both of the modulating clutch assemblies 420A and 420B are driven by the input shaft 370 through the bevel gears 382 and 388 and the tubular drive member 394. Specifically, the ring gear 388, as noted above, is secured to the tubular drive member 394. A tubular extension 422 of the ring gear 388 includes external or male splines 424, which mate with internal or female splines or gear teeth 428A, formed on a left drive collar 430A. The left drive collar 430A also includes external or male splines or gear teeth 432A which mate with complementarily configured internal or female splines or gear teeth 434A on a left clutch end bell 440A. With regard to the drive to the right modulating clutch assembly 420B, the tubular drive member 394 includes external or male splines or gear teeth 436, which engage complementarily configured female splines or gear teeth 428B on a right drive collar 430B. Correspondingly, the right drive collar 430B includes male or external splines or gear teeth 432B which are complementary to and engage internal or female splines or gear teeth 434B formed on a right clutch end bell 440B.

The clutch end bells 440A and 440B are identical but disposed in mirror image relationship. Each of the clutch end bells 440A and 440B includes internal splines 442 which drivingly engage complementarily configured external splines 444 on a first plurality of larger diameter friction clutch plates or discs 446. Interleaved with the first plurality of larger diameter friction clutch plates or discs 446 is a second plurality of smaller diameter friction clutch plates or discs 448. At least one face of each of the friction clutch plates or discs 446 and 448 includes suitable friction clutch material. Each of the smaller diameter friction clutch plates or discs 448 includes internal or female splines 450 which engage complementarily configured male or external splines 452 on a circular collar or hub 454. The hub 454 is, in turn, coupled by internal or female splines or gear teeth 456 to male splines or gear teeth 458 on respective left and right output shafts 460A and 460B for rotation therewith. The output shafts 460A and 460B may include male splines 462A and 462B.

The modulating clutch assemblies 420A and 420B also include ball ramp actuator assemblies 470A and 470B. The ball ramp actuator assemblies 470A and 470B each include a first circular camming member 472 having gear teeth 474 disposed about its periphery and a plurality of arcuate, tear drop shaped ramped recesses 476 on one face. Adjacent the first circular cam member 472 is a second circular cam member 482 having gear teeth 484 disposed about its periphery and a plurality of arcuate, tear drop shaped recesses 486 facing the similarly configured ramped recesses 476 on the first circular cam member 472. Disposed and retained within the ramped recesses 476 and 486 are a plurality of load transferring members such as ball bearings 490.

As noted above, as the camming members 472 and 482 rotate relative to one another, the ball bearings 490 move along the ramped recesses 476 and 486 and separate the first and second camming members 472 and 482. Once again, it should be understood that analogous devices such as tapered roller bearings in complementarily configured ramped recesses or opposed, oblique cam surfaces will affect similar axial motion upon relative rotation of the camming members 472 and 482 and thus are also suitable.

Adjacent the first camming member 472 is a first thrust bearing 492 which is maintained in its axial position by adjacent snap rings. Adjacent the second camming member 482 is a second thrust bearing 494. Between the friction clutch plates 446 and 448 and the second thrust bearing 496 is a circular apply plate 496. The second thrust bearing 496 allows free relative rotation between the apply plate 496 and the second camming member 482.

The ball ramp actuator assembly 470A also includes a fractional horsepower, bi-directional electric motor 500 which is secured to the housing 412A by a plurality of threaded fasteners 502. A suitable fluid tight seal (not illustrated) between the housing of the electric motor 500 and the housing 412A may be included. The electric motor 500 includes an output shaft 504 which drives a pinion 506 having gear teeth 508. The gear teeth 508 of the pinion 506 engage the gear teeth 474 and 484 on both the first camming member 472 and the second camming member 482. As noted, there are different numbers of gear teeth 474 and 484 on the respective camming members 472 and 482 such that they rotate differentially, i.e., at different speeds, thereby generating relative rotation which causes separation of the camming members 472 and 482. Such separation compresses the adjacent, associated friction clutch pack assembly and transmits torque from the drive tube 394 to the output shaft 460A.

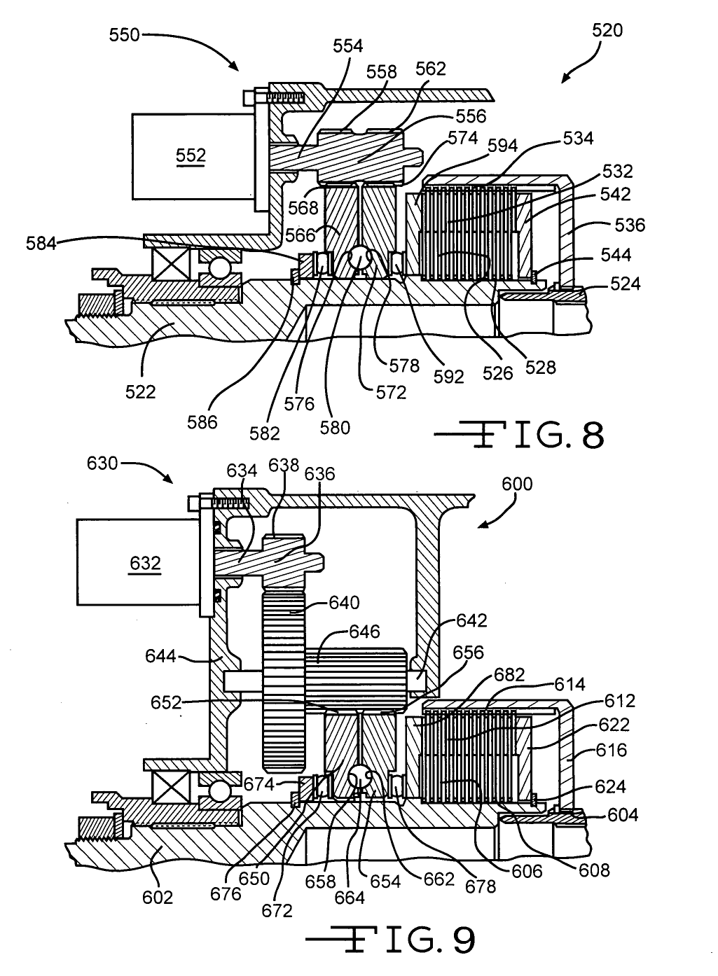

Turning now to FIG. 8, a first alternate embodiment of the ball ramp actuator is illustrated and designated by the reference number 520. Here, a shaft 522 which may be either an input shaft such as within a transfer case assembly 16 as illustrated in FIG. 2 or an output shaft as in a rear differential as illustrated in FIG. 5 and a second shaft 524 which may be an output shaft as illustrated in the transfer case assembly 16 or an input shaft as illustrated in the rear differential are coupled to and drive a respective first plurality of smaller clutch plates or disks 526 which are splined to the first shaft 522 by a plurality of interengaging male and female splines 528. The first plurality of clutch plates or disks 532 are interleaved with a second plurality of friction clutch plates or disks 532 which include a plurality of interengaging splines or gear teeth 534 which couple the second plurality of friction clutch plates or disks 532 to a bell shaped housing 536 which in turn is coupled through splines or other interengaging means such as lugs to the second shaft 524. A backing or stop plate 532 is maintained in position on the first shaft 522 by a cooperating snap ring and groove 544.

An actuator assembly 550 includes a fractional horsepower, bidirectional electric motor 552 which drives an output shaft 554. The output shaft 554 is secured to or integrally formed with a pinion 556 having a first region of gear teeth 504 having a number of gear teeth distinct from a second region of gear teeth 562. For example, the first region of gear teeth 558 may include twenty teeth whereas the second region of gear teeth 562 may include twenty-one teeth. It will be appreciated that these numbers may be varied to achieve a desired differential rotation of the driven members. Aligned with the first region of gear teeth 558 is a first camming member 566 which includes gear teeth 568 disposed about its periphery which engage the first region of gear teeth 558 on the pinion 556. Disposed adjacent the first camming member 556 is a second camming member 572 having a plurality of gear teeth 574 about its periphery which engage the second region of gear teeth 562 on the pinion 556. The number of gear teeth 568 on the first camming member 566 may be equal to or unequal to the number of gear teeth 574 on the second camming member 572. In order to achieve differential rotation of the camming members 566 and 572, however, the numbers of teeth on the first and second camming members 566 and 572 must not be such as to achieve the same drive ratio given the number of teeth on the two regions of the pinion 556.

Differential rotation may be readily achieved by utilizing the same number of gear teeth 568 and 574 on the first and second camming members 566 and 572, respectively, with the pinion 556 described above. Both of the camming members 566 and 572 include a plurality of arcuate, teardrop shaped ramped recesses 576 and 578 which receive and retain a like plurality of load transferring members such as ball bearings 580. A first thrust bearing 582 is disposed adjacent the first camming member 566 and between a flat washer 584 and a cooperating snap ring and groove 586. The first thrust bearing 582 allows free rotation of the first camming member 566 relative to the first shaft 522. The washer 584 and the snap ring and groove 586 provide a reaction force stop. Adjacent the second camming member 572 is a second thrust bearing assembly 592 which likewise allows free rotation of the second camming member 572 and transmits clutch actuating force therethrough. An apply plate 594 is disposed adjacent the second thrust bearing 592 and applies compressive, clutch actuating force to the clutch plates 526 and 532 upon relative rotation and separation of the first and second camming members 566 and 572.

It will be appreciated that the recesses 576 and 578 and the load transferring balls 580 may be replaced with other analogous mechanical elements which cause axial displacement of the camming members 566 and 572 in response to relative rotation therebetween. For example, tapered rollers disposed in complementarily configured conical helices or opposed, oblique cam surfaces may be utilized.

Turning now to FIG. 9, a second alternate embodiment of the ball ramp actuator is illustrated and designated by the reference number 600. A shaft 602 which may be either an input shaft 72 of a transfer case assembly 16 as illustrated in FIG. 2 or an output shaft of a secondary axle assembly 226 as illustrated in FIG. 7 and a second shaft 604 which may be an output shaft 82 as illustrated in the transfer case assembly 16 or an input shaft as illustrated in the secondary differential 226 are coupled to and drive a respective first plurality of smaller clutch plates or disks 606 which are splined to the first shaft 602 by a plurality of interengaging male and female splines 608. The first plurality of clutch plates or disks 606 are interleaved with a second plurality of friction clutch plates or disks 612 which include a plurality of interengaging splines or gear teeth 614 which couple the second plurality of friction clutch plates or disks 612 to a bell shaped housing 616 which in turn is coupled through splines or other interengaging means such as lugs to the second shaft 604. A backing or stop plate 622 is maintained in position on the first shaft 602 by a cooperating snap ring and groove 624.

An actuator assembly 630 includes a fractional horsepower, bi-directional electric motor 632 which drives an output shaft 634. The output shaft 634 is secured to or integrally formed with a first pinion gear 636 having gear teeth 638. The first pinion gear 636 engages and bidirectionally drives a larger spur gear 640 which is disposed upon a stub shaft 642 rotatably supported within a housing 644. The larger spur gear 640 is integrally formed with or coupled to a second pinion gear 646. The gear reduction achieved by the first pinion gear 636, the larger spur gear 640 and the second pinion gear 646 reduces the speed of the bidirectional electric motor 632 and increases its torque. The speed reduction i.e., gear reduction ratio, suitable for a particular application will be a function of the speed and torque of the electric motor 632, the angles of the ramped recesses 658 and 662, the desired engagement time of the clutch and other factors.

The second pinion gear 646 engages and drives a first camming member 650 having a first number of gear teeth 652 disposed about its periphery. Adjacent the first camming member 650 is a second camming member 654 having a second number of teeth 656 disposed about it periphery which are distinct in number from the teeth 652 on the first camming member 650. Preferably, the number of gear teeth 652 will be a hundred or more and the number of gear teeth 656 will be different only by one or two. It is apparent that a larger number of teeth will permit a larger difference in the number of teeth and that the number of teeth is loosely related to the overall size of the device. A number of teeth between 75 and 250 will likely to encompass most applications.

As in the other embodiments, the first and second camming members 650 and 654 include defined cam or ramp components which drive the members 650 and 654 axially apart from a proximate, rest position. As illustrated in FIG. 9, the first camming member includes a plurality of arcuate, teardrop shaped ramped recesses 658 and the second camming member 654 includes a like plurality of opposed arcuate, teardrop shaped ramped recesses 662. A like plurality of load transferring members such as ball bearings 664 are received and retained within the opposed arcuate, ramped recesses 658 and 662. It will be appreciated that the ramps and balls may be replaced by oblique camming surfaces and other configurations causing separation of the camming members 650 and 654 upon relative rotation.

A first thrust bearing 672 is disposed between the first camming member 650 and a flat washer 674 and a cooperating snap ring and groove 676. The first thrust bearing 672 allows free rotation of the first camming member 650 relative to the shaft 602 and the flat washer 674. The snap ring and groove 676 provide a reaction force stop. Adjacent the second camming member 654 is a second thrust bearing assembly 678 which likewise allows free rotation of the second camming member 654 and transmits clutch actuating force therethrough. An apply plate 682 is disposed adjacent the second thrust bearing 678 and applies compressive, clutch actuating force to the first plurality of clutch plates 606 and 612 upon relative rotation and separation of the first and second camming members 650 and 654.

Upon energization of the electric motor 632, the first pinion gear 636 rotates, driving the second pinion gear 646 at a reduced speed. Since the camming members 650 and 654 have different numbers of gear teeth 652 and 656, they rotate at different (differential) speeds causing relative rotation therebetween which results in axial separation of the members 650 and 654 by action of the ramped recesses 658 and 662 and the load transferring ball bearings 664, compression of the pluralities of friction clutch plates 606 and 612 and energy transfer through the clutch assembly 600.

It should be appreciated that while described above in connection with an electric motor, the invention is equally usable with pneumatic, e.g., vane, motors and hydraulic motors may also be and all are within the purview of this invention

The foregoing disclosure is the best mode devised by the inventor for practicing this invention. It is apparent, however, that devices incorporating modifications and variations will be obvious to one skilled in the art of motor driven ball ramp clutches. Inasmuch as the foregoing disclosure is intended to enable one skilled in the pertinent art to practice the instant invention, it should not be construed to be limited thereby but should be construed to include such aforementioned obvious variations and be limited only by the scope and spirit of the following claims.

I claim:

1. A clutch operator comprising, in combination,
a first rotatable member,
a second rotatable member,
means associated with said first and second members for axially separating said members upon differential rotation therebetween,
means for driving said members at distinct speeds,
whereby axial separation of said members is useful for engaging a clutch.

2. The clutch operator of claim 1 wherein said means for driving includes a drive motor having a drive pinion output, a first plurality of gear teeth disposed about said first member and a second plurality of gear teeth distinct from said first plurality of gear teeth disposed about said second member.

3. The clutch operator of claim 1 wherein said members include opposed ramped recesses and load transferring members disposed in said recesses.

4. The clutch operator of claim 3 wherein said load transferring members are ball bearings.

5. The clutch operator of claim 1 further including a pair of thrust bearings, one of said pair of thrust bearings disposed outside and adjacent each of said rotatable members.

6. The clutch operator of claim 1 further including a friction clutch assembly disposed adjacent one of said rotatable members.

7. The clutch operator of claim 1 wherein said rotatable members further include opposed, oblique cam surfaces.

8. The clutch operator of claim 1 wherein said means for driving includes a drive motor having an output pinion, said output pinion having a first set of gear teeth and a second axially disposed set of gear teeth distinct in number from said first set of gear teeth and further including gear teeth disposed about the peripheries of said rotatable members.

9. A clutch operator comprising, in combination,
a first circular member having a periphery and a first plurality of gear teeth disposed thereabout,
a second circular member having a second plurality of gear teeth distinct in number from said first plurality of gear teeth disposed thereabout,
said first and said second circular members each defining a plurality of opposed ramp features, and
a bi-directional motor having an output driving said first and said second circular members,
whereby rotation of said motor output differentially rotates said first and said second circular members.

10. The clutch operator of claim 9 further including a friction clutch disposed adjacent one of said circular members.

11. The clutch operator of claim 10 further including a thrust bearing disposed between one of said circular members and said friction clutch.

12. The clutch operator of claim 9 wherein said ramp features include opposed ramped recesses and load transferring members disposed in said recesses.

13. The clutch operator of claim 9 wherein said ramp features include opposed oblique cam surfaces.

14. The clutch operator of claim 9 wherein said means for driving includes a drive motor having a drive pinion output, a first plurality of gear teeth disposed about said first member and a second plurality of gear teeth distinct from said first plurality of gear teeth disposed about said second member.

15. The clutch operator of claim 9 wherein said means for driving includes a drive motor having an output pinion, said output pinion having a first set of gear teeth and a second axially disposed set of gear teeth distinct in number from said first set of gear teeth and further including gear teeth disposed about the peripheries of said rotatable members.

16. A friction clutch assembly comprising, in combination,
a first rotatable member,
a second rotatable member,
means associated with said first and second members for axially separating said members upon relative rotation therebetween,
means for driving said members differentially, and
a friction clutch assembly disposed adjacent said rotatable members,
whereby relative rotation between said members actuates said friction clutch assembly.

17. The clutch assembly of claim 16 wherein said means for driving includes a drive motor having a drive pinion output, a first plurality of gear teeth disposed about said first member and a second plurality of gear teeth distinct from said first plurality of gear teeth disposed about said second member.

18. The clutch assembly of claim 16 wherein said rotatable members include opposed ramped recesses and load transferring members disposed in said recesses.

19. The clutch assembly of claim 16 further including a pair of thrust bearings, one of said pair of thrust bearings disposed outside and adjacent each of said rotatable members.

20. The clutch assembly of claim 16 wherein said rotatable members further include opposed oblique cam surfaces.

21. The clutch assembly of claim 16 wherein said means for driving includes a drive motor having an output pinion, said output pinion having a first set of gear teeth and a second axially disposed set of gear teeth distinct in number from said first set of gear teeth and further including gear teeth disposed about the peripheries of said rotatable members.

22. A clutch assembly comprising, in combination,
a first rotatable member having a first plurality of gear teeth disposed thereabout,
a second rotatable member having a second plurality of gear teeth distinct in number from said first plurality of gear teeth disposed thereabout,
said first and said second circular members each defining a plurality of opposed ramp features,
a motor having an output driving said first and said second circular members,
a friction clutch assembly disposed adjacent one of said circular members,
whereby rotation of said output pinion gear differentially rotates said first and said second circular members and engages said clutch.

23. The clutch assembly of claim 22 further including a gear train operably disposed between said motor output and said first and second rotatable members said gear train having at least one intermediate gear between said motor output and said first and second members.

24. The clutch assembly of claim 22 wherein said opposed ramp features include opposed ramped recesses and load transferring members disposed in said recesses.

25. The clutch assembly of claim 22 further including a thrust bearing disposed between one of said rotatable members and said friction clutch assembly.

26. The clutch assembly of claim 22 further including one of a transfer case, rear axle clutch or twin clutch secondary differential.

27. The clutch assembly of claim 22 wherein said opposed ramp features include opposed oblique cam surfaces.
